(19) United States
(12) Patent Application Publication
(10) Pub. No.: US 2019/0337483 A1
(43) Pub. Date: Nov. 7, 2019

(54) AUTOMOBILE SECURITY DEVICE

(71) Applicant: Harold Winston, Chicago, IL (US)

(72) Inventors: Harold Winston, Chicago, IL (US); Patricia Winston, Chicago, IL (US)

(21) Appl. No.: 16/400,089

(22) Filed: May 1, 2019

Related U.S. Application Data
(60) Provisional application No. 62/665,862, filed on May 2, 2018.

(51) Int. Cl. B60R 25/10; B60R 25/104

(52) U.S. Cl. CPC B60R 25/1004; B60R 25/104

(57) ABSTRACT

A device for providing security to an automobile is presented. A user may deploy numerous devices upon an automobile. Each device has a durable adhesive backing strip suitable for installation upon a smooth surface such as glass and a pair of fastening devices which permit a user to screw or otherwise secure each device to a surface not suitable for an adhesive e.g. an automobile bumper or door. The device has a plurality of sensor arrays where each sensor array may have a plurality of sensors. The plurality of sensors may be one or more video recording units, sound recording units, infrared light recording units, audio alarms, illumination devices, motion sensors and illumination alarms. The device has a command center which receives environmental data from the sensors and provides commands to the device and/or alerts the user of the current environmental conditions. Further, the data is stored for future retrieval.

### PRIORITY

This utility application claims the benefit of U.S. Provisional Patent Application No. 62/665,862, filed on May 2, 2018, the entirety is hereby incorporated by reference.

### FIELD OF THE INVENTION

The present invention relates generally to automobile security device.

### BACKGROUND

Since the automobile was invented, mankind has been figuring out how to secure them from theft and unauthorized use. Probably the first and by far the most common way to secure motor vehicles is with the use of a conventional key lock. However, mechanical locks can easily be picked or bypassed. Next, active alarm systems were used, but required the owner to activate them when leaving the vehicle, which was often easily forgotten. Passively armed systems followed next, but countless alarm horns are easily ignored. The latest means to protect vehicles is the use of GPS systems to locate them when they are stolen. However, they only work after the vehicle is stolen. Finally, current systems only offer protection for the vehicle itself and do not provide increased security for vehicle occupants. Accordingly, there exists a need for a means by which not only vehicles can be protected in an easy manner which addresses the above shortcomings. The use of the automobile security device provides a level of security for vehicles which is leaps and bounds beyond what present technology offers.

### DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is front side view of the automobile security device 10 and an environmental view of the device 10 installed on an automobile 100, according to a preferred embodiment of the present invention.

### DESCRIPTIVE KEY

10 automobile security device
20 sensor array
25 first sensor
30 second sensor
35 third sensor
40 fourth sensor
45 fifth sensor
50 sixth sensor
55 seventh sensor
60 eight sensor
65 ninth sensor
70 solar cell
75 sensor array rechargeable battery
80 first signal
90 command center
92 keypad
93 microprocessor/memory unit
94 digital display
95 command center battery
100 automobile
150 front windshield
160 rear windshield
180 key fob
190 activation switch
200 second signal

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

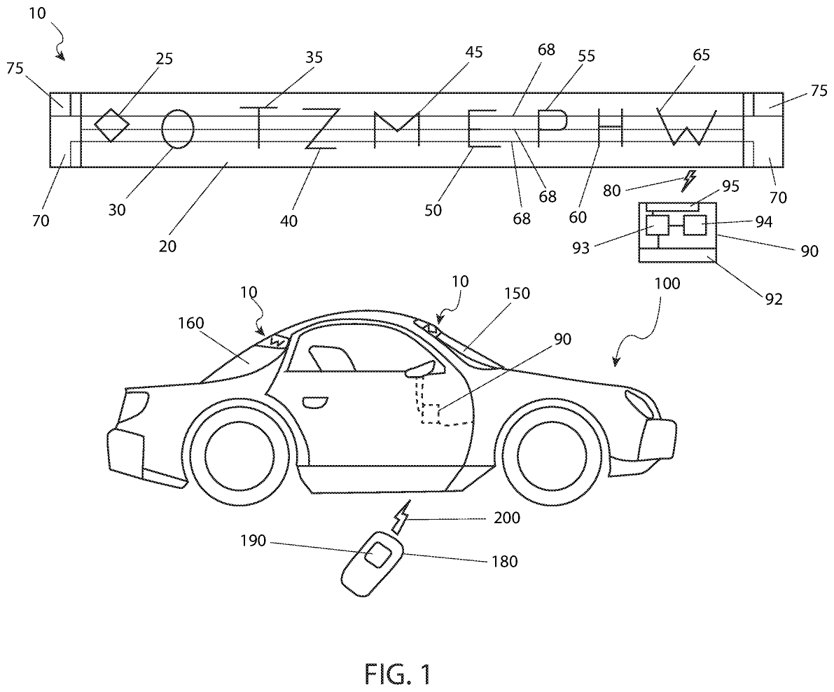

Referring to FIG. 1, disclosing an automobile security device 10 and an environmental view of the device 10 installed on an automobile 100, herein generally referred to as a device 10 and the automobile 100. The disclosed device 10 provides a user the ability to monitor the environment about an automobile upon which it is installed while simultaneously deterring theft of the automobile. Data from each device 10 is relayed to a command center 90 and stored for future use and viewing. Each device 10 may also be activated by a key fob 180 in order to deter theft—all of which will be discussed more fully below.

Referring again to FIG. 1, disclosed is the device 10 according to a preferred embodiment of the present invention. While two (2) devices 10 are shown installed on the automobile 100, it is envisioned that a user may deploy numerous such devices 10 upon an automobile 100. Each device 10 has a durable adhesive backing strip (not shown) suitable for installation upon a smooth surface such as glass and a pair of fastening devices (not shown) which permit a user to screw or otherwise secure each device 10 to a surface not suitable for an adhesive e.g. an automobile bumper or door.

Each device 10 has a clear plastic sensor array 20 within which are secured a plurality of sensors 20, 25, 30, 35, 40, 45, 50, 55, 60 and 65 in electrical communication with a sensor array a solar cell 70 and a rechargeable battery 75. Each sensor 20, 25, 30, 35, 40, 45, 50, 55, 60 and 65 is capable of wirelessly transmitting at least one (1) first signal 80 to the command center 90 wherein a data set from the first signal 80 is stored. It is envisioned that other models may have fewer or more individual sensors than the plurality of sensors 20, 25, 30, 35, 40, 45, 50, 55, 60 and 65 shown herein and therefore the number of sensors shown in the preferred embodiment should not be regarded as a limiting factor.

The plurality of sensors 20, 25, 30, 35, 40, 45, 50, 55, 60 and 65 may comprises video recording units, sound recording units, infrared light recording units, audio alarms, illumination devices, motion sensors and illumination alarms. This list is not meant to be exclusive as other sensory devices may be utilized which are not discussed herein.

The command center 90 comprises a keypad 92 in electrical communication with a microprocessor memory unit 93 which is in electrical communication with a digital display 94 which in turn is in electrical communication with a command center battery 95. The command center 90 is capable of ideally being secured within the automobile 100.

The device 10 may also be remotely activated by a key fob 180 having an activation switch 190. When activated, the key fob 180 sends a second signal 200 to each device 10 installed on the automobile 100.

The materials required to produce the disclosed device 10 are all readily available and well known to manufacturers of goods of this type. The raw materials as used in manufacture of the disclosed device 10 may best be obtained from wholesalers and manufacturers that deal in goods of that nature and assembled at a final location.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

To have access to the now opened tab opening 203 for consumption or pouring of contents of the beverage can 200, The sanitary lid 100 is turned to a direction to remove the clip 108 of the opener 109 from the tab 203 of the top surface 201 of the beverage can 200. The clip 108 of the opener 109 when configured to be in a coupling condition with the tab 202 of the top surface 201 of the beverage container 200 acts as a locking mechanism thereby preventing dirt, grim, bacteria, etc. from making contact with the top surface 201 of the beverage container 200.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An automobile security device, the device comprising:
at least one sensor array, the array comprising a plurality of sensors each in electrical communication with a rechargeable power source;
at least one solar cell in electrical communication with the rechargeable power source;
a command center, the command center being communicatively coupled to the plurality of sensors;
a key fob, the key fob being in wireless communication with the at least one sensor array, wherein the at least one sensor array being configured to record and store environmental data in the command center, wherein the command center being configured to enable a view of the environmental data; and
wherein the key fob further comprises a switch, wherein the switch being configured to activate at least one of the plurality of sensors.

2. The device of claim 1, wherein the device having a adhesive strip.

3. The device of claim 2, wherein adhesive strip being adhered to a surface.

4. The device of claim 3, wherein the surface being an automotive door.

5. The device of claim 1, wherein the at least one sensor array being a clear plastic.

6. The device of claim 1, wherein the communicative coupling being wireless.

7. The device of claim 1, wherein the command center being securely coupled in an automobile.

8. The device of claim 1, wherein the plurality of sensors being at least one of: video recording units, sound recording units, infrared light recording units, audio alarms, illumination devices, motion sensors and illumination alarms.

9. The device of claim 1, wherein the command center further comprises:
a keyboard, the keyboard being for entering commands; and
a display, the display for displaying the received environmental data.
